(19) United States
(12) Patent Application Publication
(10) Pub. No.: US 2012/0002045 A1
(43) Pub. Date: Jan. 5, 2012

(54) NON-RETRO-REFLECTIVE LICENSE PLATE IMAGING SYSTEM

(76) Inventors: Mayer Tony, Vancouver (CA); Stephen Chu, Vancouver (CA)

(21) Appl. No.: 12/672,581

(22) PCT Filed: Aug. 8, 2007
(86) PCT No.: PCT/CA07/01400

§ 371 Date: Feb. 8, 2010

(51) Int. Cl. H04N 7/18

(52) U.S. Cl. 348/143; 348/E07.085

(57) ABSTRACT

An infrared illuminator and camera system for high contrast imaging of non-retro-reflective license plates utilizing a combination of temporal filtering via pulsed LED illumination, spectral filtering using high transmission narrow band pass optical filters placed directly on the CCD sensor, and an IR sensitive camera with adjustable computer controlled settings to produce high definition, high contrast images of a wide range of both retro-reflective and non-retro-reflective surfaces including vehicle license plates, ISO shipping containers, and transport trucks with DOT ID numbers on fenders for use in weigh in motion systems, and can operate in all lighting conditions from total darkness to bright sunlight.

### BACKGROUND

Imaging systems exist which can capture and recognize license plates. Prior systems have been designed to capture images of retro-reflective license plates. Such license plates have been made to reflect a high proportion of light in order to make them more visible at night. Many states therefore use retro-reflective plates. Rear license plates can typically be read upon the headlights from a police cruiser getting close enough. Prior surveillance systems have gone a step beyond this, and have used infra-red illumination to provide reading of a target vehicle's front license plate, despite interfering light shining from that vehicle's own headlights or brake lights.

Surveillance systems previously available have been unable to capture consistently high definition, high contrast and un-blurred images of fast moving non-retro-reflective objects under difficult lighting conditions.

License plates in many parts of the world do not have retro-reflective properties. This results in difficulty obtaining sufficiently high quality images for alphanumeric data analysis. It is difficult to obtain proper exposure over wide range of conditions as non retro-reflective surfaces only reflect a twentieth as much light back to a camera compared to retro-reflective surfaces. There are also a large number of painted surfaces, such as shipping containers and trucks which are not retro-reflective. Many applications at ports and on roadways could benefit from camera technology which was able to capture high quality images of the markings on these surfaces, in troublesome ambient light conditions. Additionally, the ability to photograph images of non-retro reflective surfaces would also facilitate the ability of cameras to capture images of the drivers and/or occupants of a vehicle, in addition to reading its license plate information. This ability would enhance the usefulness of traffic cameras as violations could be traced to specific individuals.

The challenges of capturing images of non-retro reflective plates are numerous. Far less light on scene is reflected back to the camera; therefore a greater fraction of this light has to be captured to obtain proper images. This traditionally required slower shutter speeds, which resulted in image blur and increased interference from ambient light on scene including headlights and sunlight. Vehicles moving at speeds beyond 20 kph show an effect known as speed blur due to the displacement of the license plate during the period the camera shutter is open. Reducing the shutter exposure time will minimize the effect of speed blur, but also increases the required intensity of light on scene because there is now less time to collect a usable number of photons for the video frame. Another problem is that brighter illumination needed to increase the intensity of light on scene to the required level can be intrusive and disruptive to the human eye. These challenges are significant and have held back the progress of critical imaging technology for security and commercial applications.

Previous vehicle imaging systems have featured sub-optimal filter placement over a lens which inhibited compaction of the system, made use of high quality bandpass filtering technology uneconomical, and provided poor results in color information from fast-moving non-retro-reflective surfaces.

### SUMMARY OF THE INVENTION

This infrared illuminator and camera system for high contrast imaging of license plates that are not retro-reflective, works in lighting conditions from complete darkness to direct oncoming headlights or bright sunlight from any angle and can capture clear images of vehicles and their license plates even when moving in excess of 100 mph. The high quality narrow band-pass filter fits directly over a CCD sensor to reduce ambient light intake. Because the filter fits over the CCD rather than the lens, a smaller, less expensive filter can be used, reducing cost with no reduction of quality. A high lens aperture setting and rotating fast shutter speeds enhance field depth and reduce smearing of images of high speed targets. High power output infra-red LEDs deliver three to four times greater illumination than is typical on scene and their duty cycle is synchronized with the camera to achieve a threshold of visibility through flexibility in system configuration.

The present invention works by utilizing a combination of features to overcome the extreme challenges inherent in obtaining high resolution, un-blurred images of both retro-reflective and non-retro-reflective objects moving at high velocities. The present invention combines temporal filtering via rapidly pulsed LED illumination from high powered LED illuminators to reduce the intrusiveness of bright illumination on the human eye; an IR sensitive camera with a controllable 3-stage cycle of different camera settings varying shutter and gain to capture the right amount of light on scene while minimizing speed blur; spectral filtering using high transmission narrow band pass optical filters placed directly on the CCD sensor to reduce the distorting impact of ambient light remote camera configuration adjustment capability based on RS-232 serial control for optimal configuration of aperture setting; lens configuration; camera shutter exposure including rotating shutter to capture variation in license plates in a single camera configuration (i.e. to capture both retro-reflective and non-retro-reflective plates and plates of differing brightness and contrast); camera gain settings; specified power on target to produce required video signal level; and a selected field of illumination for specific image target distance.

As a result of the novel arrangement, the imaging system of the present invention can produce high definition, high contrast images of a wide range of both retro-reflective and non-retro-reflective surfaces including vehicle license plates, ISO shipping containers, and transport trucks with DOT ID numbers on fenders for use in weigh in motion systems, and can operate in all lighting conditions from total darkness to bright sunlight.

The present invention, a surveillance system for capturing high contrast, low smear images even from high speed surfaces that are not retro-reflective, includes:

a) an illuminator control module controlling an illuminator of light emitting diodes that emit light in a narrow spectrum of wavelengths.

b) an electronic image sensor that is sensitive to light energy in a range covering at least the narrow spectrum

c) a lens for the electronic image sensor to focus incoming light;

d) a lens aperture control module that enables a selection of aperture settings for an iris of the lens;

e) a shutter speed control module that enables a selection of shutter speed settings for the electronic image sensor; and

f) a bandpass filter that passes light having a wavelength within the narrow spectrum and blocks light wavelengths outside that range;

in which the shutter speed control module can set shutter speeds for the electronic image sensor within a series of shutter speeds, and can provide the electronic image sensor with open-aperture temporal filtering that is synchronized with a pulse of light energy from the illuminator.

The shutter speed control module can set exposure for the electronic image sensor within a series of shutter speeds and gain, and can provide the electronic image sensor with open-aperture temporal filtering that is synchronized with a pulse of light energy from the illuminator.

In an excellent working embodiment, the surveillance system has:

a) an illuminator control module controlling a high power illuminator of narrow spectrum light emitting diodes having peak light energy emission in a range between 820 and 880 nanometers of wavelength;

b) an electronic image sensor that is sensitive to light energy between 400 and 1000 nanometers of wavelength;

c) a lens aperture control module with fast aperture settings for the electronic image sensor in a range of F8 to F12;

d) a shutter speed control module for the electronic image sensor with fast shutter speeds in a range from 1/500 second to 1/10,000 second and gain of 0-12 dB;

and the shutter speed control module can rotate shutter speeds and gain for the electronic image sensor within a series of shutter speeds and gain, each shutter speed having an open-aperture duration substantially synchronized with a pulse of light energy from the illuminator.

The bandpass filter component should have a notch frequency substantially matching light frequency emitted by the narrow spectrum light emitting diodes. It is advantageous for the bandpass filer to:

a) substantially match the illuminator regarding peak light transmission wavelength and half power/half transmission wavelength;

b) be smaller than the lens and fit directly over the light sensor;

c) allow greater than 90% transmission at its specified wavelength and less than 50% transmission at wavelengths greater than 30 nm from its specified wavelength at a center portion of the filter;

d) be directly mounted to the CCD via optical epoxy or double sided adhesive tape.

Further details of an excellent embodiment of the system include:

a) a default shutter speed is 1/1000 second and is automatically adjusted shorter depending on ambient light conditions;

b) the light emitting diodes have a duty cycle that is substantially synchronized with an open-aperture duration for the image sensor;

c) the shutter speed control module for the electronic image sensor provides fast shutter speeds in a range from 1/500 second to 1/10,000 second.

Even tiny details such as non-retro-reflective state and insurance details on both retro-reflective and non-retro-reflective fast-moving license plates can be captured with such a system. Similarly non-retro-reflective details such as the driver and passenger faces can be captured, for processing the number of occupants of vehicles in HOV lanes, and their facial characteristics for identification purposes.

Variation in license plate type or surface type can be captured with a single camera configuration via rotating exposures. Typically the shuttering and gain would be cycled through three different settings to remove excess light and the optimal image resolution would be obtained for data analysis.

Light interference from illuminator flashback from a common window within the camera housing is blocked by a donut surrounding the camera lens. The system is remotely configurable manually or automatically by software via an advanced serial control.

The system works in both low and high ambient light conditions. Higher power infra-red illumination than is typical in prior surveillance system is added to the scene as necessary to improve image capture for non retro-reflective surfaces. The higher power illumination is enabled by having an LED power supply heat sink C-shaped bracket board and a separate LED illuminator heat sink C-shaped bracket board adapted to slide under pressure into a heat-sink housing for the system.

### BRIEF DESCRIPTION OF THE DRAWINGS

FIG. 1 is a schematic diagram showing the main features of the system.

FIG. 2 is a perspective overview of the overall system

FIG. 3A is an illustration of a non-retro-reflective front license plate and vehicle image captured by a conventional license plate imaging system.

FIG. 3B is an illustration of a non-retro-reflective front license plate and vehicle image captured by the imaging system of the present invention.

FIG. 4A is an illustration of a non-retro-reflective rear license plate and vehicle image captured by a conventional license plate imaging system.

FIG. 4B is an illustration of a non-retro-reflective rear license plate and vehicle image captured by the imaging system of the present invention.

FIG. 5A is an illustration of a shipping container number captured by a conventional license plate imaging system.

FIG. 5B is an illustration of a shipping container number captured by the imaging system of the present invention.

FIG. 6A is a side perspective of the components of a camera system with conventional filter placement over the camera lens.

FIG. 6B is a side perspective of the components of the system of the present invention showing placement of a small bandpass notch filter directly over on a CCD image sensor.

### DETAILED DESCRIPTION

This invention provides an infrared LED illuminator and camera control system to capture images of alphanumeric or symbolic identifiers. For example, high-contrast images of both reflective and non-reflective vehicle license plates and cargo container identifiers may be captured. The system works in all ambient light conditions, ranging from bright sunlight, to dim light, to dark, to zero ambient light. Captured images of license plate letter and number combinations can be viewed remotely, or converted to text format with optical character recognition computer hardware and software. Processed data can then be compared to data files listing license numbers to provide further information about the owner of a licensed vehicle. A decision can be made quickly about whether to allow a vehicle to proceed through an access point, or whether to take other action. The system uses an enhanced sensitivity infrared (IR) camera, synchronized with a pulsed infrared LED illuminator, which controls sampling to maximize night-time capture clarity, and with shutter speeds set up to capture clear license plate images of fast moving vehicles, even when headlights interfere with human observation of the plates. Optical and electronic filters on the capture device pass only those infrared wavelengths in the range of the illuminator, thereby reducing ambient light outside this range. Filtering prevents image smear and sensor overload caused by headlights at night and by reflected glare from the sun in daytime. Both circumstances degrade input image quality to the point where the captured image cannot be converted to meaningful data.

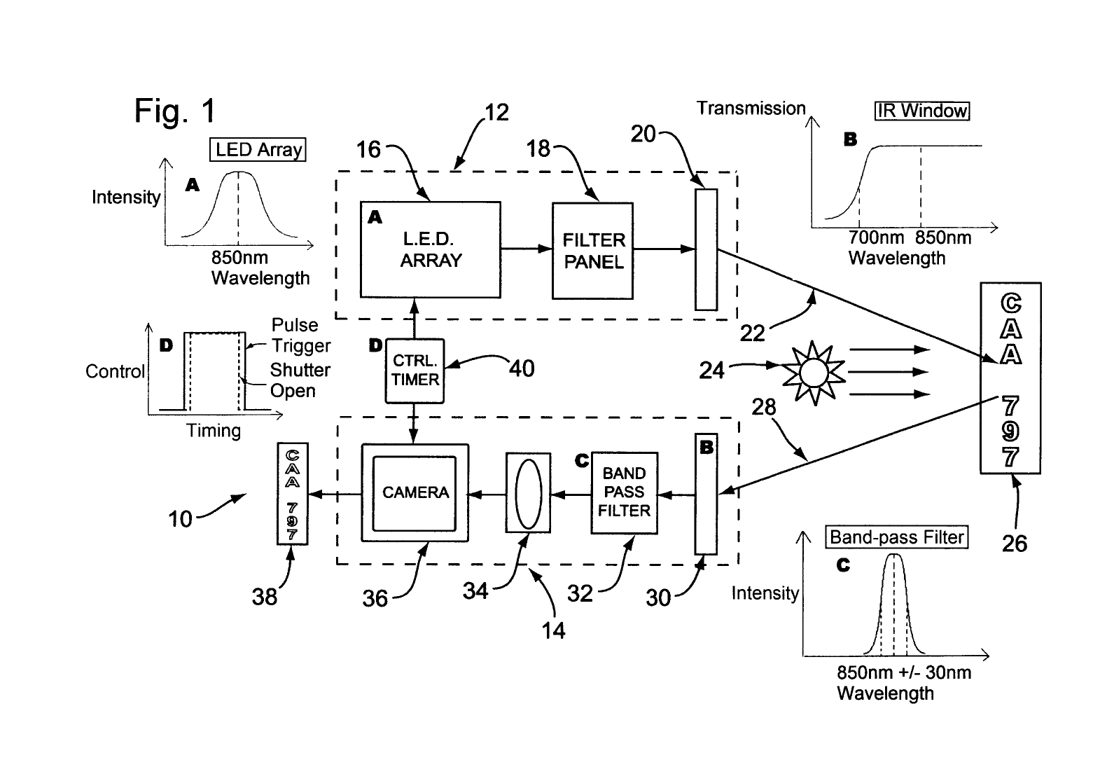

FIG. 1 diagrams an infrared image capture device 10, comprised of an infrared illuminator 12, a capture device 14, a control timer 40, and a representative object 26. The illuminator 12 is comprised of an LED Array 16, a filter panel 18, and an IR Output Window 20. The capture device 14 is comprised of an IR Window 30, band-pass filter 32, lens 34, and camera 36. The positions of the band pass filter 32 and the lens 34 could be reversed. The control timer 40 operates between the illuminator 12 and the capture device 14. The object 26 is shown being illuminated by both the IR output 22 from the IR Illuminator 12, and any ambient light sources 24, and its reflected light 28 is received by the capture device 14.

FIG. 1 also illustrates the outputs at four stages in the device 10, by means of graphs A to D. Graph A shows the wavelength output intensity from the LED array 16. Graph B shows the wavelengths passed by the IR Window 30. Graph C shows the wavelength output after band-pass filtering 32. Graph D shows how the control timer 40 synchronizes camera 36 shutter openings with LED array 16 pulsations. Finally, the camera 36 provides an image output 38, shown here as a copy of the representative object 26, and which is suitable for optical character recognition and further image processing.

The functions and interactions of each element in FIG. 1 will now be described.

The LED array 16 is a multiplicity of electrically connected infrared light emitting diodes (LEDs), turned on by the control timer 40. The control timer 40 also synchronizes pulsations of the LED array 16 with shutter openings of the camera 36. As shown by Graph D, as the camera 36 shutter is opened, the LED array 16 is pulsed.

Light from the LED array 16 is a uniform output peaking at 850 nanometers (see Graph A), which then passes through the filter panel 18, which diverges (spreads or diffuses) the light into a specific pattern suitable for maximum illumination from the IR Output Window 20, which produces an active 850 nanometers IR light. The illuminator 12 shines its IR output 22 on the object, which can be retro-reflective or non retro-reflective license plates or cargo container sidewall identifiers or similar machine readable information. The object 26 is also illuminated by ambient light 24 from the sun, vehicle headlights, overhead lighting, street lights, etc. IR output 22 and ambient light 24 combine into reflected light 28 from the object 26, returning to the capture device 14.

Light entering the capture device 14, passes through the IR window 30, which allows only wavelengths greater than 700 nanometers. (See Graph B) Light is further processed by a band-pass notch filter 32, as is shown by Graph C. Only 850 nanometer IR light filtered to plus/minus 30 nanometers is allowed through the lens 34 and into the camera 36. The camera 36 is of a fixed aperture which limits how much light is received by the image output 38 device. The camera 36 also has a fixed shutter or limited automatic exposure shutter to control the exposure of light. The output from the camera 36 goes to the image output 38 device, which can be any means of digital or electronic image capture circuitry, such as charge coupled devices, or the like. A copy of the plate is shown as the output, as would be seen by an OCR reader.

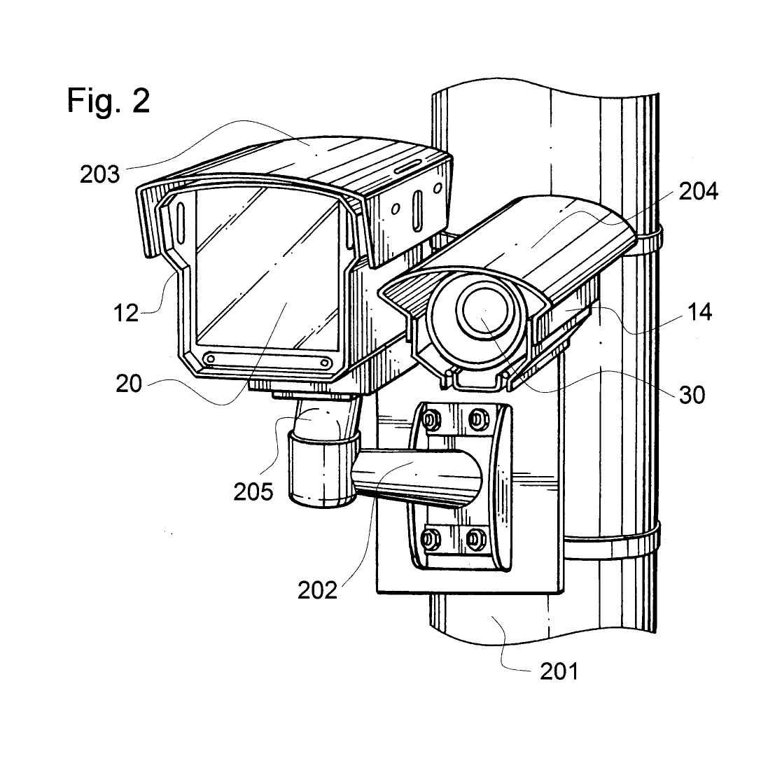

Referring to FIG. 2, a perspective overview of the non-retro-reflective license plate imaging system is shown, with infrared illuminator 12 and image capture device 14. The infrared illuminator 12 is affixed to a post 201 via support 202. Its IR output window and internal components are shielded from the elements with protective housing cover 203. Similarly the camera 14 has a protective housing cover 204 which shields its IR window 30 from the elements. The system is compact and the infrared illuminator 12 and image capture device 14 can be adjusted via ball-socket 205 to an optimal angle for the acquisition of target images.

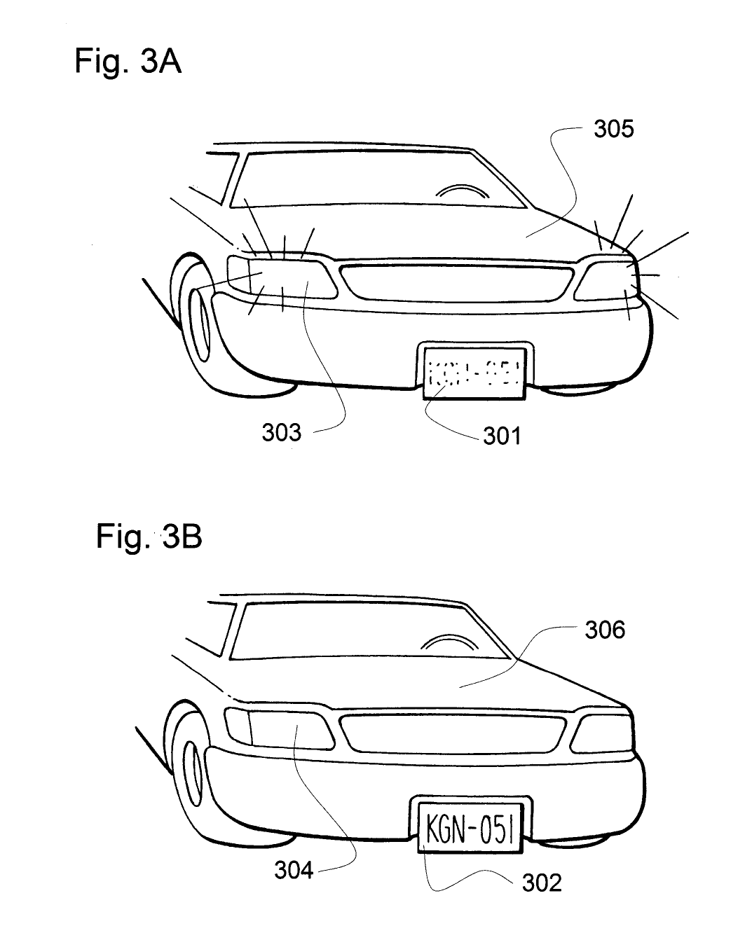

Referring to FIG. 3A, an illustration a non-retro-reflective front license plate 301 and vehicle image 305 captured by a conventional license plate imaging system is shown. Glare such as that emanating from the headlight 303 results in a blurry license plate image 301. In contrast, referring to FIG. 3B, a higher quality vehicle image 306 is captured by the system of the present invention with no visible glare from headlight 304 and a clear and easily identifiable license plate image 302.

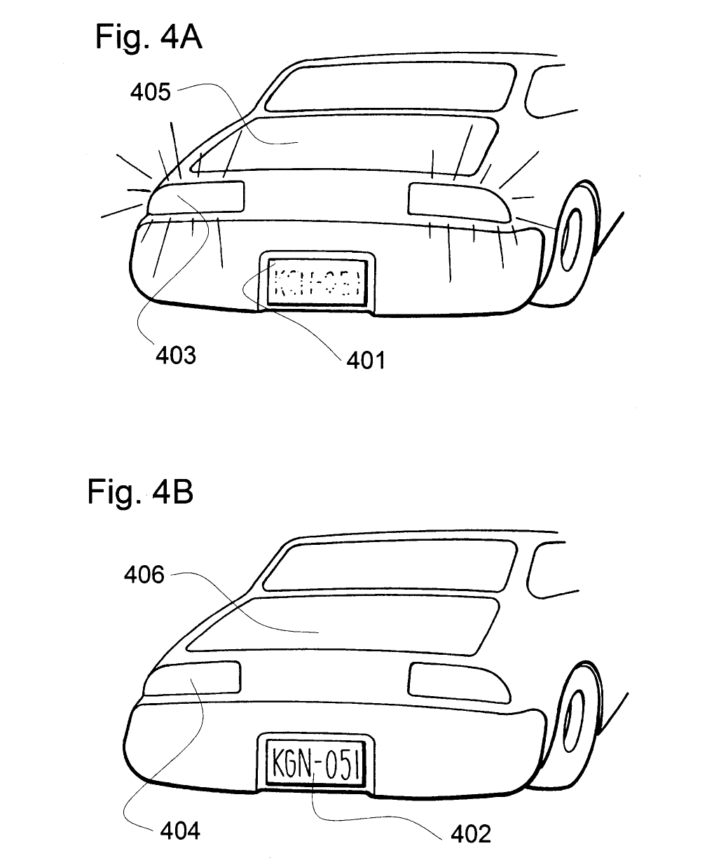

Referring to FIG. 4A an illustration a non-retro-reflective rear license plate 401 and vehicle image 405 captured by a conventional license plate imaging system is shown. Glare such as that emanating from the brakelight 403 results in a blurry license plate image 401. In contrast, referring to FIG. 4B, a higher quality vehicle image 406 is captured by the system of the present invention with no visible glare from brakelight 404 and a clear and easily identifiable license plate image 402.

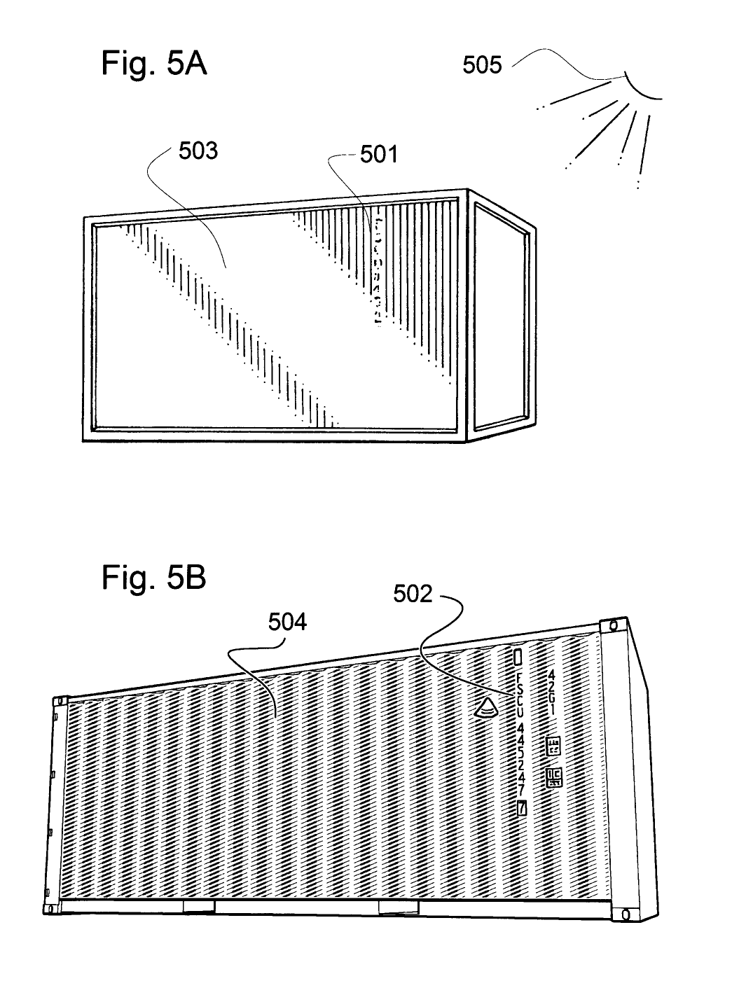

Referring to FIG. 5A an illustration of a shipping container 503 and its identifying number 501 as captured by a conventional license plate imaging system is shown. The number 501 is partially obscured by shadows and the image quality is reduced by glare from the sun 505. In contrast FIG. 5B shows an illustration of the shipping container captured by the imaging system of the present invention. There is no sun glare and the serial number at 502 is clear and easily readable from the image. The system will show the detail in the image in very good high contrast—including the manufactured folds (as at 504) that are typical on the sides of containers and even the triangular, rectangular and other numeric insignia around 502.

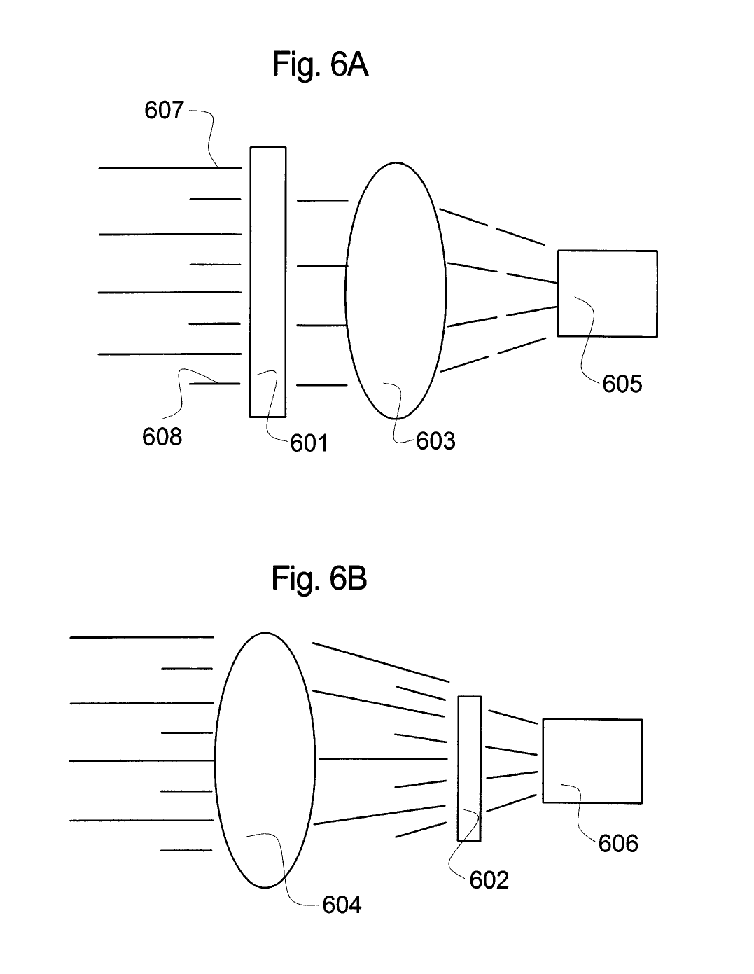

Referring to FIG. 6A a side perspective of the arrangement of the components of an image capture system are shown with filter 601 placed in front of lens 603 which bends light towards CCD 605. The filter 601 permits the entry of light of desired wavelength indicated by the short lines such as 608 while blocking entry of light of undesired wavelength indicated by the long lines such as 607. A major drawback of this arrangement is that the filter 601 must be large enough to cover the lens 603, which requires more scarce and expensive materials and more space In contrast FIG. 6B shows the arrangement of the present system with lens 604 permitting light of all wavelength indicated by the lines 609 and 610 to pass through it where the undesired wavelength indicated by the long lines such as 609 are then filtered by the small bandpass notch filter 602 which is positioned directly over a CCD image sensor 606. This arrangement saves valuable filter material and space enabling smaller, more cost-effective, and more efficient system designs.

The combination of the above described features of the non-retro-reflective license plate imaging system including its automatically adjustable controls for shuttering, pulsing, and camera gain settings, its exceptional high quality narrow band-pass filtering technology, and its novel arrangement of system components yields exceptionally high quality imaging of varied or mixed surface types under a great variety of lighting and environmental conditions. The system is optimized to deliver excellent images which provide critical data for information systems serving today's information dependent business, administrative, and security applications.

Alternate implementations include using illumination and matching filter wavelength other than 850 nm centerpoint, for example 940 nm, 880 nm or 730 nm in the infrared, or visible wavelengths such as 660 nm, 550 nm and others. Different default lens aperture settings would be used for different standard lighting conditions and imaging applications.

The within-described invention may be embodied in other specific forms and with additional options and accessories without departing from the spirit or essential characteristics thereof. The presently disclosed embodiment is therefore to be considered in all respects as illustrative and not restrictive, the scope of the invention being indicated by the appended claims rather than by the foregoing description, and all changes which come within the meaning and range of equivalence of the claims are therefore intended to be embraced therein.

We claim:

1. A surveillance system for capturing high contrast, low smear images even from high speed surfaces that are not retro-reflective, comprising:
a) an illuminator control module controlling an illuminator of light emitting diodes that emit light in a narrow spectrum of wavelengths.
b) an electronic image sensor that is sensitive to light energy in a range covering at least the narrow spectrum
c) a lens for the electronic image sensor to focus incoming light;
d) a lens aperture control module that enables a selection of aperture settings for an iris of the lens.
e) a shutter speed control module that enables a selection of shutter speed settings for the electronic image sensor;
f) a bandpass filter that passes light having a wavelength within the narrow spectrum and blocks light wavelengths outside that range;
in which the shutter speed control module can set shutter speeds for the electronic image sensor within a series of shutter speeds, and can provide the electronic image sensor with open-aperture temporal filtering that is synchronized with a pulse of light energy from the illuminator.

2. The surveillance system of claim 1, in which the bandpass filter substantially matches the illuminator regarding peak light transmission wavelength and half power/half transmission wavelength.

3. The surveillance system of claim 1, in which a default shutter speed is 1/1000 second and the shutter speed is automatically adjusted shorter depending on ambient light conditions.

4. The surveillance system of claim 1, in which the bandpass filter has a notch frequency substantially matching light frequency emitted by the narrow spectrum light emitting diodes.

5. The surveillance system of claim 1, in which the bandpass filter is smaller than the lens and fits directly over the light sensor.

6. The surveillance system of claim 1, in which the light emitting diodes have a duty cycle that is substantially synchronized with an open-aperture duration for the image sensor.

7. The surveillance system of claim 1, in which the shutter speeds and gain are rotated within a range to give a selection of images from which optimal resolution images can be selected for image data processing.

8. The surveillance system of claim 6, in which a shutter speed control module for the electronic image sensor provides fast shutter speeds in a range from 1/500 second to 1/10,000 second.

9. The surveillance system of claim 1, further comprising a remote serial control for adjustment of the system.

10. The surveillance system of claim 1, in which the illuminator emits pulsed infrared illumination peaking in a spectrum of 820 to 880 nanometers.

11. The surveillance system of claim 1, in which the illuminator emits pulsed infrared illumination substantially within a spectrum of 820 to 880 nanometers.

12. The surveillance system of claim 1, in which the temporal filtering is synchronized with 1000 uS LED pulsing.

13. The surveillance system of claim 1, in which the band pass filter allows greater than 90% transmission at its specified wavelength and less than 50% transmission at wavelengths greater than 30 nm from its specified wavelength at a center portion of the filter.

14. The surveillance system of claim 1, in which the system is calibrated and optimized via a remote-control module to capture non-smeared, high-contrast, alphanumeric images, from fast-moving vehicle license plates that are not retro-reflective.

15. The surveillance system of claim 1, in which the system is calibrated and optimized via remote control module to capture non-smeared, high-contrast, alphanumeric images, from distant shipping containers.

16. The surveillance system of claim 1, having:
a) an illuminator control module controlling a high power illuminator of narrow spectrum light emitting diodes having peak light energy emission in a range between 820 and 880 nanometers of wavelength;
b) an electronic image sensor that is sensitive to light energy between 400 and 1000 nanometers of wavelength;
c) a lens aperture control module with fast aperture settings, for an optical lens, in a range of F8 to F12;
d) a shutter speed control module for the electronic image sensor with fast shutter speeds in a range from 1/500 second to 1/10,000 second;
in which the shutter speed control module can rotate shutter speeds for the electronic image sensor within a series of shutter speeds, each shutter speed having an open-aperture duration substantially synchronized with a pulse of light energy from the illuminator.

17. The surveillance system of claim 1, in which the bandpass filter:
a) substantially matches the illuminator regarding peak light transmission wavelength and half power/half transmission wavelength;
b) is smaller than the lens and fits directly over the light sensor;
c) allows greater than 90% transmission at its specified wavelength and less than 50% transmission at wavelengths greater than 30 nm from its specified wavelength at a center portion of the filter.

18. The surveillance system of claim 1, in which
a) a default shutter speed is 1/1000 second and is automatically adjusted faster or slower depending on ambient light conditions;
b) the light emitting diodes have a duty cycle that is substantially synchronized with an open-aperture duration for the image sensor;
c) the shutter speed control module for the electronic image sensor provides fast shutter speeds in a range from 1/500 second to 1/10,000 second.

19. The surveillance system of claim 16, in which
a) the bandpass filter substantially matches the illuminator regarding peak light transmission wavelength and half power/half transmission wavelength;
b) the bandpass filter is smaller than the lens and fits directly over the light sensor;
c) the bandpass filter has frequency notches substantially matching light frequencies emitted by the narrow spectrum light emitting diodes;
d) the bandpass filter allows greater than 90% transmission at its specified wavelength and less than 50% transmission at wavelengths greater than 30 nm from its specified wavelength at a center portion of the filter;
e) a default shutter speed is 1/1000 second and is automatically adjusted faster or slower depending on ambient light conditions;
f) the light emitting diodes have a duty cycle that is substantially synchronized with an open-aperture duration for the image sensor;
g) the shutter speeds are rotated within a range to give a selection of images from which optimal resolution images can be selected for image data processing;
h) the shutter speed control module for the electronic image sensor provides fast shutter speeds in a range from 1/500 second to 1/10,000 second;
i) the system is calibrated and optimized via a remote-control module to capture non-smeared, high-contrast, alphanumeric images, from fast-moving vehicle license plates that are not retro-reflective.
